(19) United States
(12) Patent Application Publication
(10) Pub. No.: US 2021/0197797 A1
(43) Pub. Date: Jul. 1, 2021

(54) CONTROL SYSTEM FOR VEHICLE

(71) Applicant: Mazda Motor Corporation, Aki-gun (JP)

(72) Inventors: Daisuke Umetsu, Aki-gun (JP); Yasumasa Imamura, Aki-gun (JP)

(21) Appl. No.: 17/102,083

(22) Filed: Nov. 23, 2020

(30) Foreign Application Priority Data
Dec. 25, 2019 (JP) 2019-234262

(51) Int. Cl. B60W 30/045; B60W 30/18; B60W 40/06; B60W 50/08; B60W 10/20; B60W 10/18

(52) U.S. Cl. CPC B60W 30/045; B60W 30/18127; B60W 40/06; B60W 2710/0666; B60W 10/20; B60W 10/18; B60W 2540/18; B60W 50/082

(57) ABSTRACT

A control system for a vehicle is provided, which includes a steering wheel configured to be operated by a driver, a steering angle sensor configured to detect a steering angle corresponding to operation of the steering wheel, and a controller configured to set an additional deceleration to be applied to the vehicle based on the steering angle detected by the steering angle sensor to control a vehicle posture when the steering wheel is turned, and applies the additional deceleration to the vehicle. The controller sets the additional deceleration larger when the vehicle travels off road than when the vehicle does not travel off road.

### TECHNICAL FIELD

The present disclosure relates to a control system for a vehicle, which controls a posture of the vehicle according to steering.

### BACKGROUND OF THE DISCLOSURE

Conventionally, a technology for controlling a vehicle posture is known, which reduces torque given to a vehicle to cause the vehicle to decelerate or slow down when a driver operates a steering wheel so that a cornering operation of the driver becomes natural and stable. According to this technology, by promptly adding a load to front wheels at the time of steering operation, a frictional force between the front wheels and the road surface increases and a cornering force of the front wheels increases accordingly. Therefore, the turn-in ability of the vehicle in an early stage of entering a curve improves, thereby improving the response to a turning operation of the steering wheel (i.e., steering stability). As a result, it becomes possible to achieve a control of the vehicle posture as the driver intended. Note that in the following, such a control of the posture of the vehicle according to the steering operation is suitably referred to as a “vehicle posture control.”

Meanwhile, for example, JP2011-105096A discloses a technology for performing a longitudinal acceleration control by adjusting driving and braking forces of each wheel so that, during a turning of a vehicle, a movement state of the vehicle becomes suitable according to a lateral acceleration occurring on the vehicle. The technology disclosed in JP2011-105096A particularly suppresses an intervention of the longitudinal acceleration control when the vehicle travels off road. Thus, an occurrence of acceleration and deceleration by the intervention of the longitudinal acceleration control is suppressed on scenes where the acceleration and deceleration are not needed.

Meanwhile, also when the vehicle travels off road (hereinafter, suitably referred to as “during off-road traveling”), it is desirable to appropriately control the vehicle posture by the vehicle posture control described above according to the steering operation by the driver. However, during off-road traveling, if the vehicle posture control is executed similarly to when traveling on a normal road (on road) which is not the off road (hereinafter, suitably referred to as “during on-road traveling”), the control may not appropriately achieve the desired vehicle posture. This is because the sinking of a vehicle body front part accompanying the occurrence of the deceleration by the vehicle posture control tends to be insufficient during off-road traveling, due to pitching of the vehicle by irregularity in the road surface, and a change in the friction coefficient of the off road.

Note that the term “off road” as used herein means so-called “off road” (rough road) which typically corresponds to a non-paved road surface into which a vehicle can enter (e.g., places with grass, gravel, sands, mud, rocks, etc.). When traveling such off road, the vehicle tends to vibrate, for example, the lateral acceleration, the yaw rate, and the vehicle speed of the vehicle fluctuate more than given amounts. On the other hand, the normal road surface which is not off road means so-called “on road” which typically corresponds to a paved road surface. Hereinafter, the normal road surface which is not such an off road is suitably referred to as “on road.” Note that the off road also includes a road surface which is paved but causes the fluctuations of the lateral acceleration, the yaw rate, and the vehicle speed of the vehicle more than the given amounts, because the road surface condition is poor (e.g., a road surface with numerous irregularities or with a frequently-varying friction coefficient).

### SUMMARY OF THE DISCLOSURE

The present disclosure is made in order to solve the problems of the conventional technology described above, and one purpose thereof is to provide a control system for a vehicle, which applies an additional deceleration to the vehicle in order to control a vehicle posture when a turning operation of a steering wheel is carried out to appropriately achieve a desired vehicle posture also during off-road traveling.

According to one aspect of the present disclosure, a control system for a vehicle is provided, which includes a steering wheel configured to be operated by a driver, a steering angle sensor configured to detect a steering angle corresponding to operation of the steering wheel, and a controller configured to set an additional deceleration to be applied to the vehicle based on the steering angle detected by the steering angle sensor to control a vehicle posture when the steering wheel is turned, and applies the additional deceleration to the vehicle. The controller sets the additional deceleration larger when the vehicle travels off road than when the vehicle does not travel off road.

According to this configuration, in the vehicle posture control in which the additional deceleration is applied to the vehicle when the steering wheel is turned, the controller increases the additional deceleration larger during off-road traveling compared to during on-road traveling (i.e., when the vehicle does not travel off road). In detail, in a situation where a vehicle body front part is difficult to sink due to the pitching of the vehicle and the change in the friction coefficient by irregularity of a road surface, which occurs during off-road traveling, the controller applies the comparatively large additional deceleration in the vehicle posture control. Thus, the insufficient sinking of the vehicle body front part when adding the deceleration by the vehicle posture control is solved, and therefore, the vehicle turning performance by the vehicle posture control can be secured appropriately. Therefore, according to this configuration, even when the steering wheel is turned during off-road traveling, the desired vehicle posture can be achieved.

The control system may further include a switch for selecting at least an off-road traveling mode as a traveling mode of the vehicle. When the off-road traveling mode is selected by the switch, the controller may set the additional deceleration larger than the additional deceleration when the off-road traveling mode is not selected. According to this configuration, when the off-road traveling mode is selected by the driver operating the switch, the controller determines that the vehicle is traveling off road and increases the additional deceleration set in the vehicle posture control. Thus, since the mode of the additional deceleration set in the vehicle posture control is changed when the driver positively operates the switch to select the off-road traveling mode as the traveling mode, the uncomfortable feeling given to the driver can be suppressed appropriately by this change.

The controller may increase the additional deceleration as the steering angle detected by the steering angle sensor increases, and set the additional deceleration larger when the vehicle travels off road than when the vehicle does not travel off road, when compared at the same steering angle. According to this configuration, the controller sets the additional deceleration based on the steering angle of the steering wheel when the vehicle posture control is executed, and when setting the additional deceleration according to the steering angle in this way, the controller makes the additional deceleration larger during off-road traveling than during on-road traveling at the same steering angle. Thus, when the turning operation of the steering wheel is performed by the same steering angle during off-road traveling and during on-road traveling, the additional deceleration applied during off-road traveling can be appropriately made larger than the additional deceleration applied during on-road traveling. Moreover, according to this configuration, since the controller increases the additional deceleration as the steering angle increases, the effectiveness of the vehicle posture control can be secured in the range where the demand of the turn-in ability of the vehicle is high. On the other hand, since the additional deceleration is made smaller as the steering angle decreases, the controller can suppress the large intervention of the vehicle posture control when the turning of the steering wheel is started and when the operating amount of the steering wheel by the driver is small.

The control system may further include a drive source configured to generate torque for driving the vehicle. The controller may control the drive source so that the generated torque of the drive source is reduced to apply the additional deceleration to the vehicle. According to this configuration, by reducing the torque generated by the drive source (e.g., an engine, an electric motor), the desired additional deceleration can be applied to the vehicle suitably.

The control system may further include a braking system configured to give a braking force to the vehicle. The controller may control the braking system so that the braking force of the braking system is given to the vehicle to give the additional deceleration to the vehicle. According to this configuration, by applying the braking force by the braking system (e.g., a brake), the desired additional deceleration can be applied to the vehicle suitably.

The control system may further include a generator configured to be driven by wheels of the vehicle and regenerate power. The controller may control the generator so that the generator regenerates the power to apply the additional deceleration to the vehicle. According to this configuration, by causing the generator to regenerate the electrical power so that the braking force by the regeneration is given to the vehicle, the desired additional deceleration can be applied to the vehicle suitably.

The controller may calculate a steering speed based on the steering angle detected by the steering angle sensor, and set the additional deceleration larger as the steering speed increases. According to this configuration, the additional deceleration which suits the steering operation by the driver can be applied to the vehicle suitably in the vehicle posture control.

The controller may include a first map and a second map defining gains to be used for correcting the additional deceleration calculated according to a steering speed. Both the first map and the second map may be defined so that the gain becomes larger as the steering angle increases. The gain may be defined to be larger in a range of the second map where the steering angle is below a given value than in a range of the first map where the steering angle is below the given value. When the switch is off, the controller may control the vehicle so that the additional deceleration is corrected based on the gain calculated from the first map, and when the switch is on, the controller may control the vehicle so that the additional deceleration is corrected based on the gain calculated from the second map.

The gain in a range of the second map where the steering angle is above the given value may be the same as the gain in a range of the first map where the steering angle is above the given value.

The gains of the first map and the second map in the range where the steering angle is above the given value may be 1 so that the additional deceleration calculated according to the steering speed is used as-is.

### BRIEF DESCRIPTION OF DRAWINGS

FIG. 1 is a block diagram illustrating the overall configuration of a vehicle on which a control system for the vehicle according to a first embodiment of the present disclosure is mounted.

FIG. 2 is a block diagram illustrating an electrical configuration of the control system for the vehicle according to the first embodiment of the present disclosure.

FIG. 3 is a flowchart of a vehicle posture control processing according to the first embodiment of the present disclosure.

FIG. 4 is a flowchart of an additional deceleration setting processing according to the first embodiment of the present disclosure.

FIG. 5 is a map illustrating a relationship between an additional deceleration and a steering speed according to the first embodiment of the present disclosure.

FIG. 6 is a map which defines a gain for correcting the additional deceleration according to the first embodiment of the present disclosure.

FIG. 7 is a time chart illustrating temporal changes in parameters relevant to the vehicle posture control according to the first embodiment of the present disclosure.

FIG. 8 is a flowchart of a vehicle posture control processing according to a second embodiment of the present disclosure.

FIG. 9 is a time chart illustrating temporal changes in the parameters relevant to the vehicle posture control according to the second embodiment of the present disclosure.

FIG. 10 is a block diagram illustrating the overall configuration of a vehicle on which a control system for the vehicle according to a third embodiment of the present disclosure is mounted.

FIG. 11 is a block diagram illustrating an electrical configuration of the control system for the vehicle according to the third embodiment of the present disclosure.

FIG. 12 is a flowchart of the vehicle posture control processing according to the third embodiment of the present disclosure.

FIG. 13 is a time chart illustrating temporal changes in the parameters relevant to the vehicle posture control according to the third embodiment of the present disclosure.

### DETAILED DESCRIPTION THE DISCLOSURE

Hereinafter, control systems for a vehicle according to embodiments of the present disclosure will be described with reference to the accompanying drawings.

### First Embodiment

First, a control system for a vehicle according to a first embodiment of the present disclosure is described.

### (System Configuration)

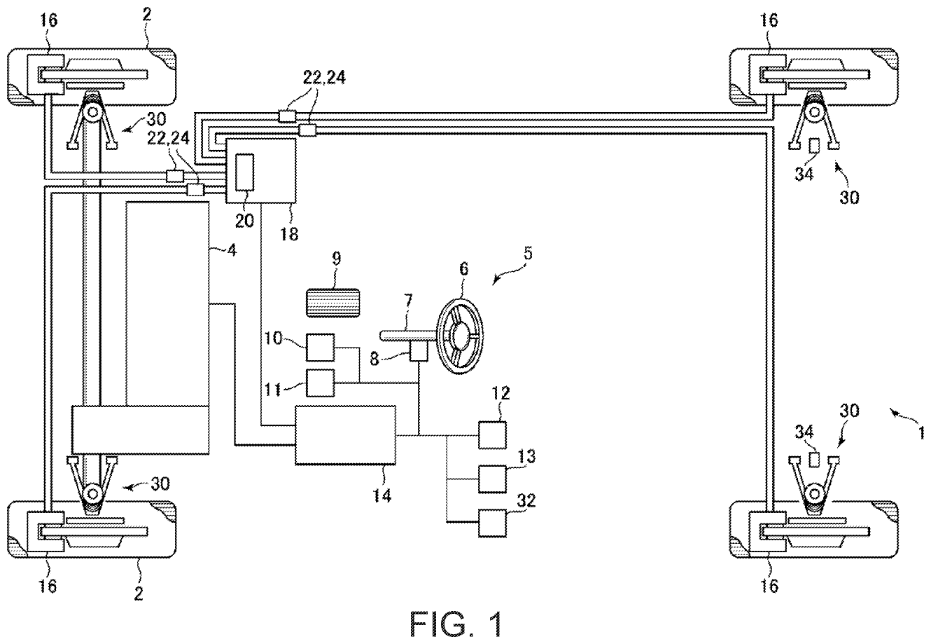

FIG. 1 is a block diagram illustrating the overall configuration of a vehicle on which a control system for the vehicle according to a first embodiment of the present disclosure is mounted.

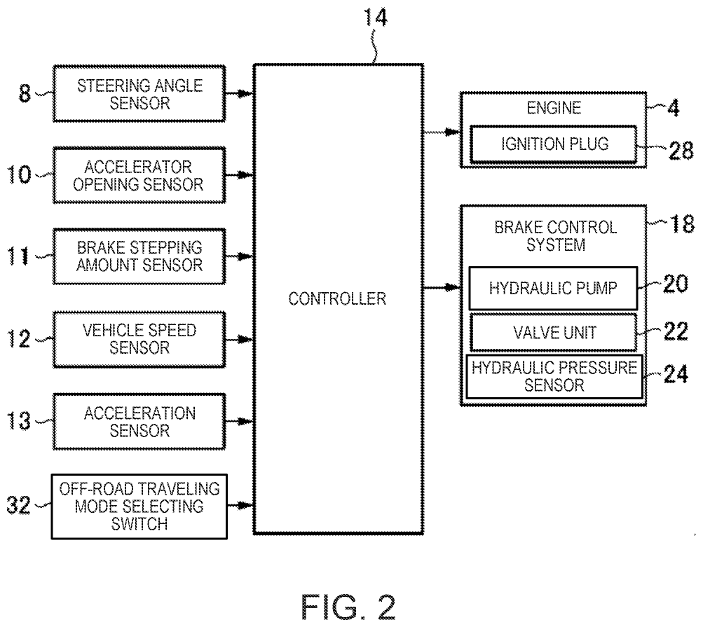

In FIG. 1, the reference character “1” illustrates a vehicle on which the control system for the vehicle according to this embodiment is mounted. An engine 4 is mounted on the vehicle body front part of the vehicle 1 as a drive source which drives drive wheels (left and right front wheels 2 in the example of FIG. 1). The engine 4 is an internal combustion engine, such as a gasoline engine or a diesel engine, and is a gasoline engine having an ignition plug 28 (see FIG. 2) in this embodiment.

The vehicle 1 also includes a steering device 5 having a steering wheel 6 and a steering shaft 7 for steering the vehicle 1, a steering angle sensor 8 which detects a turning angle of the steering wheel 6, an accelerator opening sensor 10 which detects an accelerator opening corresponding to a stepping amount of an accelerator pedal 9, a brake stepping amount sensor 11 which detects a stepping amount of a brake pedal, a vehicle speed sensor 12 which detects a vehicle speed, and an acceleration sensor 13 which detects an acceleration. These sensors output respective detected values to a controller 14. This controller 14 is comprised of, for example, a PCM (Power-train Control Module). Further, each wheel of the vehicle 1 is attached to the vehicle body through a suspension 30 including a spring (elastic member) and a suspension arm. Note that the steering angle sensor 8 may detect, instead of the turning angle of the steering wheel 6, various properties of the steering system (a rotation angle of a motor which gives assisting torque, a displacement of a rack in a rack and pinion mechanism), and a steered angle (tire angle) of the front wheels 2, as the steering angle.

The vehicle 1 also includes a brake control system 18 which supplies brake fluid pressure to a wheel cylinder and a brake caliper of a brake device (braking system) 16 provided to each wheel. The brake control system 18 is provided with a hydraulic pump 20 which generates the brake fluid pressure required for generating a braking force of the brake device 16 provided to each wheel. The hydraulic pump 20 is, for example, driven by electric power supplied from a battery, and therefore, it is capable of generating the brake fluid pressure required for generating the braking force of each brake device 16 even when the brake pedal is not stepped on. The brake control system 18 also includes a valve unit 22 (in detail, a solenoid valve) provided to a hydraulic pressure supply line to the brake device 16 of each wheel and for controlling the hydraulic pressure supplied from the hydraulic pump 20 to the brake device 16 of each wheel. For example, an opening of the valve unit 22 is changed by adjusting power supply from the battery to the valve unit 22. The brake control system 18 also includes a hydraulic pressure sensor 24 which detects a hydraulic pressure supplied from the hydraulic pump 20 to the brake device 16 of each wheel. The hydraulic pressure sensor 24 is, for example, disposed at a connecting part of each valve unit 22 and the hydraulic pressure supply line downstream thereof, and detects the hydraulic pressure downstream of each valve unit 22 and outputs a detected value to the controller 14. Such a brake control system 18 calculates the hydraulic pressure to be supplied independently to the wheel cylinder and the brake caliper of each wheel based on a braking-force command value inputted from the controller 14 and the detected value of the hydraulic pressure sensor 24, and controls a rotational speed of the hydraulic pump 20 and an opening of the valve unit 22 according to the hydraulic pressures.

Next, an electrical configuration of the control system for the vehicle according to the first embodiment of the present disclosure is described with reference to FIG. 2. FIG. 2 is a block diagram illustrating the electrical configuration of the control system for the vehicle according to the first embodiment of the present disclosure.

Based on the detection signals of the sensors 8, 10, 11, 12, and 13 and the detection signals outputted from various sensors which detect an operating state of the vehicle 1, the controller 14 according to this embodiment outputs a control signal to each part of the engine 4 (e.g., a throttle valve, a turbocharger, a variable valve mechanism, the ignition plug 28, a fuel injection valve, and an exhaust gas recirculation (EGR) system) in order to control the driving force given to the vehicle 1, and outputs a control signal to each of the hydraulic pump 20 and the valve unit 22 of the brake control system 18 in order to control the braking force given to the vehicle 1.

Moreover, in addition to the detection signals of the sensors 8, 10, 11, 12, and 13, a signal corresponding to ON/OFF of an off-road traveling mode selecting switch 32 for selecting an off-road traveling mode as a traveling mode set to the vehicle 1 is inputted into the controller 14. The traveling mode set to the vehicle 1 includes, in addition to the off-road traveling mode, a sport mode and a towing mode. The off-road traveling mode selecting switch 32 is operated by the driver when the vehicle 1 travels the rough road (off road), and at this time, an ON signal is outputted to the controller 14 from the off-road traveling mode selecting switch 32. For example, the off-road traveling mode selecting switch 32 is a button switch (press switch) or a touch panel provided to a display unit installed in a vehicle cabin (in this case, the driver touches the touch panel to select the off-road traveling mode). Note that the off-road traveling mode may be selected by voice of the driver, and in this case, a processing unit (may be the controller 14) which analyzes the voice inputted from a microphone functions as the off-road traveling selecting switch 32.

The controller 14 and the brake control system 18 are controllers each comprised of circuitry based on a well-known microcomputer. For example, they are each comprised of one or more microprocessors as a central processing unit (CPU) which executes a program, and memory which is comprised of RAM (Random Access Memory) and ROM (Read Only Memory) and stores the program and data, and an I/O bus which performs input and output of an electrical signal.

Note that in this embodiment, the system including the engine 4, the steering wheel 6, the controller 14, the brake control system 18, the steering angle sensor 8, and the off-road traveling mode selecting switch 32 is an example of a “control system for the vehicle” in the present disclosure.

### (Vehicle Posture Control)

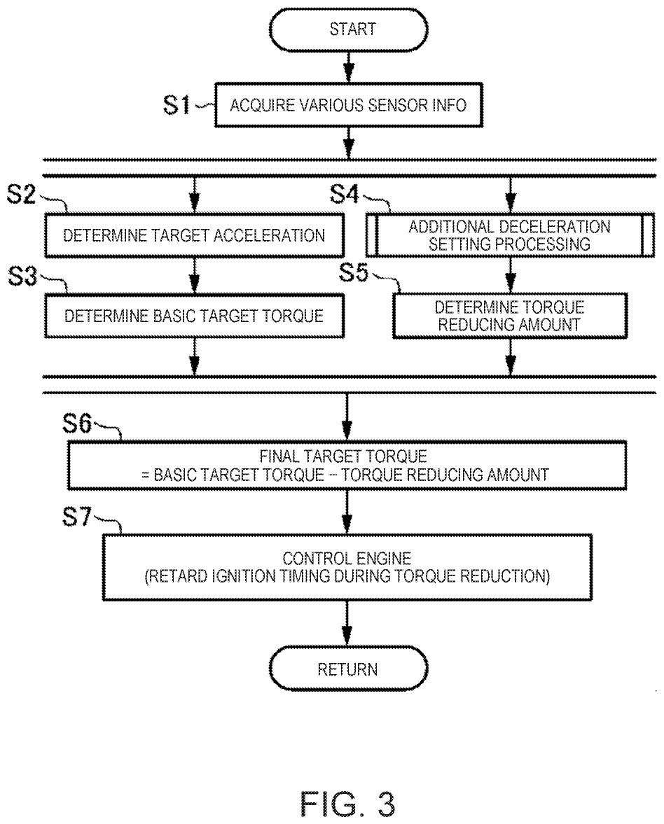

Next, concrete control contents executed by the control system for vehicle in the first embodiment are described. First, an overall flow of a vehicle posture control processing executed by the control system for vehicle in the first embodiment of the present disclosure is described with reference to FIG. 3. FIG. 3 is a flowchart of the vehicle posture control processing according to the first embodiment of the present disclosure.

The vehicle posture control processing of FIG. 3 is started when an ignition switch of the vehicle 1 is turned on and the power is supplied to the controller 14, and is repeatedly executed at a given period (e.g., 50 ms).

As illustrated in FIG. 3, as the vehicle posture control processing is started, the controller 14 acquires, at Step S1, various sensor information on the operating state of the vehicle 1. In detail, the controller 14 acquires the detection signals outputted from the various sensors described above as information on the operating state, which include the steering angle detected by the steering angle sensor 8, the accelerator opening detected by the accelerator opening sensor 10, the brake-pedal stepping amount detected by the brake stepping amount sensor 11, the vehicle speed detected by the vehicle speed sensor 12, the acceleration detected by the acceleration sensor 13, the fluid pressure detected by the hydraulic pressure sensor 24, ON/OFF of the off-road traveling mode selecting switch 32, the stroke detected by a stroke sensor 34, and the gear stage currently set to a transmission of the vehicle 1.

Next, at Step S2, the controller 14 sets a target acceleration based on the operating state of the vehicle 1 acquired at Step S1. In detail, the controller 14 selects an acceleration characteristics map corresponding to the current vehicle speed and the current gear stage from acceleration characteristics maps (created in advance and stored in the memory) which define various vehicle speeds and various gear stages, and determines the target acceleration corresponding to the current accelerator opening while referring to the selected acceleration characteristics map.

Next, at Step S3, the controller 14 determines a basic target torque of the engine 4 for achieving the target acceleration determined at Step S2. In this case, the controller 14 determines the basic target torque within a range of torque which the engine 4 is outputable, based on the current vehicle speed, gear stage, road surface gradient, road surface etc.

Moreover, in parallel to the processing at Steps S2 and S3, the controller 14 performs an additional deceleration setting processing at Step S4 where it sets a deceleration to be applied to the vehicle 1 based on a steering speed of the steering wheel 6 in order to control the vehicle posture. The details of the additional deceleration setting processing will be described later.

Next, at Step S5, the controller 14 determines a torque reducing amount based on the additional deceleration set by the additional deceleration setting processing at Step S4. In detail, the controller 14 determines the torque reducing amount required for achieving the additional deceleration by lowering the generated torque of the engine 4, based on the current vehicle speed, gear stage, and road surface gradient, etc. which are acquired at Step S1.

After the processing at Steps S3 and S5, the controller 14 determines, at Step S6, a final target torque based on the basic target torque determined at Step S3 and the torque reducing amount determined at Step S5. For example, the controller 14 uses a value obtained by subtracting the torque reducing amount from the basic target torque, as the final target torque.

Next, at Step S7, the controller 14 controls the engine 4 so as to output the final target torque set at Step S6. In detail, the controller 14 determines various properties required for achieving the final target torque (e.g., an air filling amount, a fuel injection amount, an intake air temperature, an oxygen concentration, etc.) based on the final target torque set at Step S6 and the engine speed, and it controls actuators which drive respective components of the engine 4 based on the properties. In this case, the controller 14 sets limiting values and limiting ranges corresponding to the properties and sets a controlled variable of each actuator so that the property conforms to the limiting value and the limiting range, and executes the control.

In more detail, if the engine 4 is a gasoline engine, the controller 14 reduces the generated torque of the engine 4 by retarding an ignition timing of the ignition plug 28 from an ignition timing when the basic target torque is used as the final target torque. On the other hand, if the engine 4 is a diesel engine, the controller 14 reduces the generated torque of the engine 4 by decreasing the fuel injection amount from a fuel injection amount when the basic target torque is used as the final target torque. After Step S7, the controller 14 ends the vehicle posture control processing.

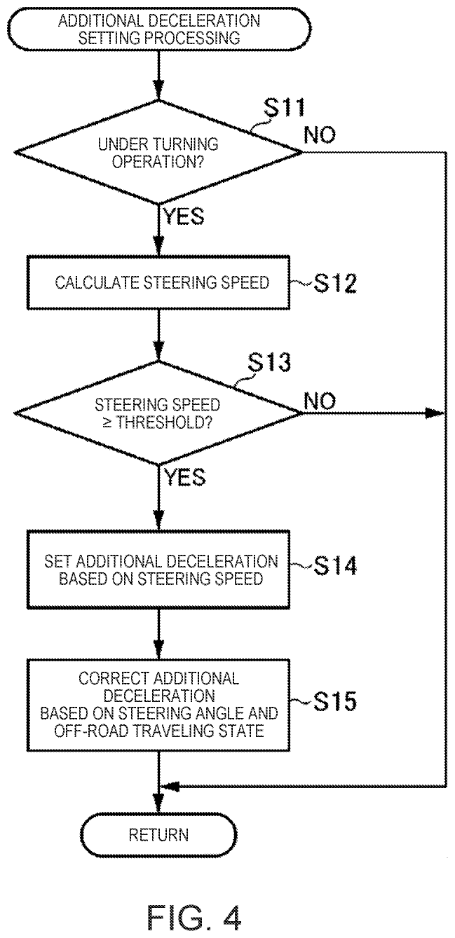

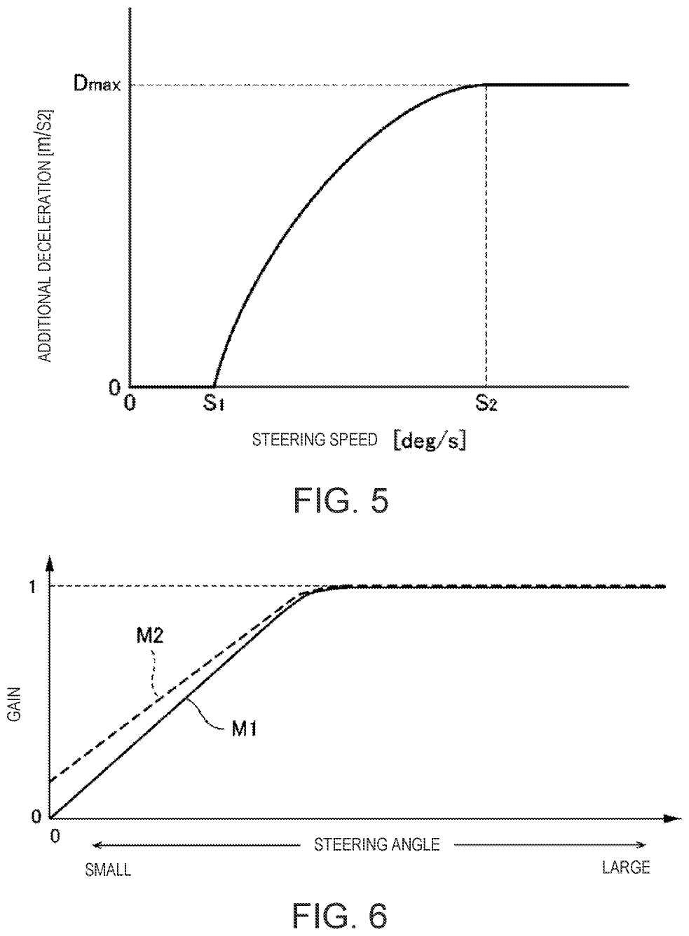

Next, the additional deceleration setting processing in the first embodiment of the present disclosure is described with reference to FIGS. 4 to 6. FIG. 4 is a flowchart of the additional deceleration setting processing according to the first embodiment of the present disclosure. FIG. 5 is a map illustrating a relationship between the additional deceleration and the steering speed according to the first embodiment of the present disclosure. FIG. 6 is a map which defines a gain for correcting the additional deceleration according to the first embodiment of the present disclosure.

When the additional deceleration setting processing is started, the controller 14 determines, at Step S11, whether the steering wheel 6 is under a turning operation (i.e., the steering angle (absolute value) is increasing). As a result, if it is under the turning operation (Step S11: YES), the controller 14 shifts to Step S12, where it calculates the steering speed based on the steering angle acquired from the steering angle sensor 8 at Step S1 in the vehicle posture control processing of FIG. 3.

Next, at Step S13, the controller 14 determines whether the steering speed is at or above a given threshold S1. As a result, if the steering speed is at or above the threshold S1 (Step S13: YES), the controller 14 shifts to Step S14, where it sets the additional deceleration based on the steering speed. This additional deceleration is a deceleration to be applied to the vehicle 1 according to the steering operation in order to control the vehicle posture as the driver intended.

In detail, the controller 14 sets the additional deceleration corresponding to the steering speed calculated at Step S12 based on the relationship between the additional deceleration and the steering speed illustrated in the map of FIG. 5. The horizontal axis in FIG. 5 indicates the steering speed, and the vertical axis indicates the additional deceleration. As illustrated in FIG. 5, if the steering speed is below the threshold S1, the corresponding additional deceleration is zero. That is, if the steering speed is below the threshold S1, the controller 14 will not execute the control for adding the deceleration to the vehicle 1 based on the steering operation. On the other hand, if the steering speed is at or above the threshold S1, the additional deceleration corresponding to the steering speed increases gradually to a given upper limit Dₘₐₓ as the steering speed increases. That is, as the steering speed increases, the additional deceleration increases and a rate of the increase is reduced. The upper limit Dₘₐₓ is set as a deceleration at which the driver does not sense a control intervention even if the deceleration is added to the vehicle 1 according to the steering operation (e.g., 0.5 m/s²≈0.05 G). Moreover, if the steering speed is above a threshold S2 which is larger than the threshold S1, the additional deceleration is maintained at the upper limit Dₘₐₓ.

Next, at Step S15, the controller 14 corrects the additional deceleration set at Step S14 based on an off-road traveling state of the vehicle 1 (either a state where the vehicle 1 travels off road, or a state where the vehicle 1 does not travel off road, which is a state where the vehicle 1 travels on road) and the steering angle acquired at Step S1 of the vehicle posture control processing of FIG. 3, corresponding to ON/OFF of the off-road traveling mode selecting switch 32 acquired at Step S1. In detail, the controller 14 corrects the additional deceleration by using the gain for correcting the additional deceleration defined in the map of FIG. 6.

In FIG. 6, the horizontal axis indicates the steering angle, and the vertical axis indicates the gain for correcting the additional deceleration (0≤gain≤1). Moreover, in FIG. 6, a map M1 represented by a solid line indicates a map which is applied when the vehicle 1 does not travel off road, in other words, when the vehicle 1 travels on road (during on-road traveling), and a map M2 represented by a broken line indicates a map which is applied when the vehicle 1 travel off road (during off-road traveling). When the off-road traveling mode selecting switch 32 is OFF, the controller 14 determines that the vehicle 1 travels on road, and therefore, the map M1 is selected. Then, the controller 14 acquires the gain according to the current steering angle from the map M1, and corrects the additional deceleration set at Step S14 by using this gain. On the other hand, when the off-road traveling mode selecting switch 32 is ON, the controller 14 determines that the vehicle 1 travels off road, and therefore, the map M2 is selected. Then, the controller 14 acquires the gain according to the current steering angle from the map M2, and corrects the additional deceleration set at Step S14 by using this gain. The controller 14 corrects the additional deceleration by multiplying the additional deceleration set at Step S14 by a value corresponding to the gain (0≤gain≤1). Then, the controller 14 ends the additional deceleration setting processing, and returns to the main routine.

As illustrated in FIG. 6, both the maps M1 and M2 are defined so that the gain applied according to the steering angle becomes larger as the steering angle increases. In more detail, while the gain increases toward “1” as the steering angle increases within a range where the steering angle is below a given value (e.g., 40° to 60°), the gain is fixed to “1” regardless of the steering angle within a range where the steering angle is above the given value. According to such a gain, the correction is performed by using the gain smaller than 1 so that the additional deceleration becomes smaller within the range where the steering angle is small. Therefore, a large intervention of the vehicle posture control can be suppressed, when the turning of the steering wheel 6 is started, and when the operating amount of the steering wheel 6 by the driver is small. On the other hand, within the range where the steering angle is large, since the gain is fixed to 1, the additional deceleration is not corrected, that is, the additional deceleration set at Step S14 is used as-is. Therefore, the effectiveness of the vehicle posture control can be secured in a range where the operating amount of the steering wheel 6 by the driver is large and a demand of turn-in ability of the vehicle 1 is high.

Moreover, as illustrated in FIG. 6, within the range where the steering angle is below the given value, the gain according to the steering angle is larger in the map M2 applied during off-road traveling as the whole than the map M1 applied during on-road traveling. That is, the maps M1 and M2 are defined so that the gain applied during off-road traveling becomes larger than the gain applied during on-road traveling at the same steering angle (in other word, the steering angle corresponding to the same gain is smaller during off-road traveling than during on-road traveling). By correcting the additional deceleration using such a gain, the additional deceleration set during off-road traveling becomes larger than the additional deceleration set during on-road traveling at the same steering angle. Thus, it becomes possible to appropriately achieve the desired vehicle posture also during off-road traveling.

Note that although in the above example it is determined whether the vehicle 1 travels off road based on ON/OFF of the off-road traveling mode selecting switch 32, the present disclosure is not limited to the determination using the off-road traveling mode selecting switch 32. In another example, the controller 14 may determine by using a known approach whether the vehicle 1 travels off road based on the variations in the lateral acceleration, the yaw rate, and the vehicle speed, which occur on the vehicle 1.

On the other hand, if the steering wheel is not under a turning operation at Step S1l (Step S11: NO), or if the steering speed is below the threshold S1 at Step S13 (Step S13: NO), the controller 14 ends the additional deceleration setting processing without setting the additional deceleration, and returns to the main routine.

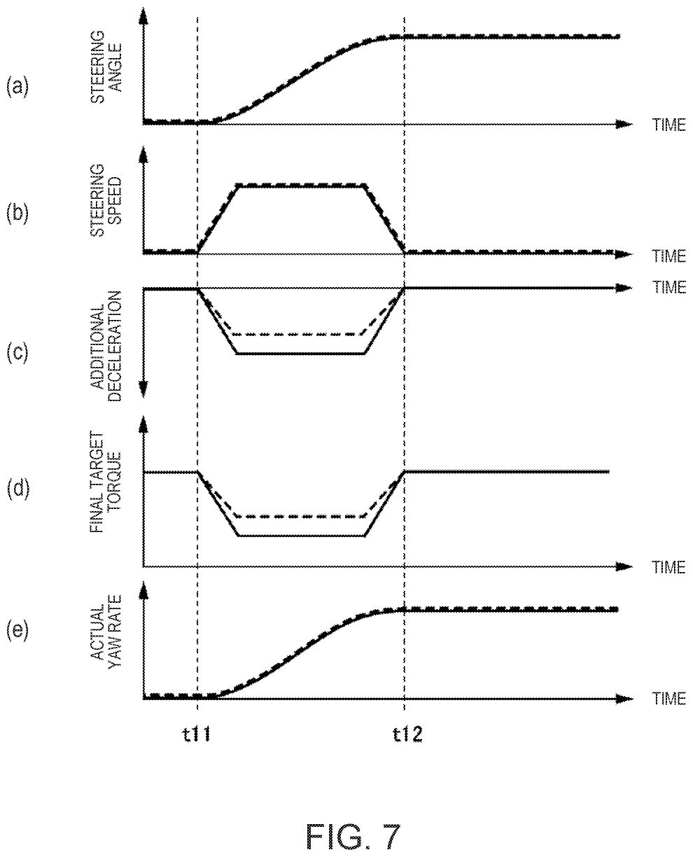

Next, operation of the control system for the vehicle according to the first embodiment of the present disclosure is described with reference to FIG. 7. FIG. 7 is a time chart illustrating temporal changes in the various parameters relevant to the vehicle posture control when the vehicle 1 on which the control system according to the first embodiment of the present disclosure is mounted is turned.

In FIG. 7, chart (a) indicates the steering angle, chart (b) indicates the steering speed, chart (c) indicates the additional deceleration, chart (d) indicates the final target torque, and chart (e) indicates the actual yaw rate. In FIG. 7, a solid line indicates the changes in the parameters when the vehicle 1 travels off road (during off-road traveling), and a broken line indicates the changes in the parameters when the vehicle 1 travels on road (during on-road traveling). Here, similar turning operations of the steering wheel 6 are performed both during off-road traveling and during on-road traveling (charts (a) and (b)).

As illustrated in chart (a), the turning operation of the steering wheel 6 is performed from Time t11. In this case, from Time t11 to Time t12, as illustrated in chart (b), the steering speed becomes at or above the threshold S1, and the additional deceleration is set as illustrated in chart (c) based on the steering speed. In detail, although the steering speed is the same during off-road traveling and during on-road traveling, the additional deceleration (absolute value) is larger during off-road traveling than during on-road traveling. This is because, since the steering angle is the same during off-road traveling and during on-road traveling (chart (a)), the gain applied for correcting the additional deceleration becomes larger during off-road traveling than during on-road traveling (see the maps M1 and M2 of FIG. 6). That is, it is because the correction is made by using the gain so that the additional deceleration (absolute value) becomes larger during off-road traveling than during on-road traveling. According to such an additional deceleration, the final target torque is set as illustrated in chart (d). In detail, during off-road traveling, the final target torque is smaller than during on-road traveling (i.e., the reduced amount of the generated torque of the engine 4 becomes larger). Then, by controlling the engine 4 to generate such a final target torque, the actual yaw rate as illustrated in chart (e) is exhibited by the vehicle 1. In detail, the almost same actual yaw rate is exhibited by the vehicle 1 during off-road traveling and during on-road traveling.

Thus, when the vehicle 1 travels off road, the controller 14 uses the map M2 defined according to the steering angle to correct the additional deceleration (absolute value) so that the additional deceleration becomes larger in the additional deceleration setting processing, and controls the engine 4 so that the reduced amount of the generated torque becomes larger than when the vehicle 1 travels on road. Therefore, the pitching moment for sinking the vehicle body front part when the deceleration is applied to the vehicle 1 can be strengthened, as compared with during on-road traveling. Thus, even in the situation where the vehicle body front part is difficult to sink due to the pitching of the vehicle and the change in the friction coefficient by irregularity of the road surface, which occurs during off-road traveling, the insufficient sinking of the vehicle body front part when giving the deceleration by the vehicle posture control is solved, and therefore, the vehicle turning performance by the vehicle posture control can be secured appropriately. As a result, as illustrated in chart (e), the suitable actual yaw rate is exhibited by the vehicle 1 by the vehicle posture control, without depending on whether the vehicle 1 travels off road, and therefore, the desired vehicle turning performance can be obtained.

### (Operation and Effects)

Next, operation and effects of the control system for the vehicle according to the first embodiment of the present disclosure is described.

According to this embodiment, the controller 14 makes the additional deceleration applied to the vehicle posture control larger during off-road traveling than during on-road traveling. Thus, it becomes possible to appropriately achieve the desired vehicle posture also during off-road traveling. That is, by applying the additional deceleration set comparatively large during off-road traveling, the insufficient sinking of the vehicle body front part by the vehicle posture control can be solved appropriately, and it becomes possible to achieve the desired vehicle turning performance.

Moreover, according to this embodiment, when the off-road traveling mode is selected by the driver operating the off-road traveling mode selecting switch 32, the controller 14 determines that the vehicle travels off road, and increases the additional deceleration to set. Thus, since the mode of the additional deceleration set in the vehicle posture control is changed when the driver positively operates the switch 32 to select the off-road traveling mode as the traveling mode, the uncomfortable feeling given to the driver by this change can be suppressed appropriately.

Moreover, according to this embodiment, the controller 14 sets the additional deceleration based on the steering angle of the steering wheel 6 when the vehicle posture control is executed, and when setting the additional deceleration according to the steering angle in this way, the controller 14 makes the additional deceleration larger during off-road traveling than during on-road traveling at the same steering angle. Thus, when the turning operation of the steering wheel 6 is performed by the same steering angle during off-road traveling and during on-road traveling, the additional deceleration applied during off-road traveling can be appropriately made larger than the additional deceleration applied during on-road traveling.

Moreover, according to this embodiment, since the additional deceleration is made smaller as the steering angle decreases, the controller 14 can suppress the large intervention of the vehicle posture control when the turning of the steering wheel 6 is started and when the operating amount of the steering wheel 6 by the driver is small. On the other hand, since the controller 14 increases the additional deceleration as the steering angle increases, the effectiveness of the vehicle posture control can be secured in the range where the demand of the turn-in ability of the vehicle 1 is high.

### Second Embodiment

Next, a second embodiment of the present disclosure is described. In the first embodiment, the posture control of the vehicle 1 is executed by reducing the generated torque of the engine 4 when a turning operation of the steering wheel 6 is carried out. However, in the second embodiment, when the turning operation of the steering wheel 6 is carried out, the set additional deceleration is added to the vehicle 1 by generating the braking force by the brake device 16. Note that in the following, as for the same configuration and processing as the first embodiment, description thereof is suitably omitted. That is, the configuration and processing which are not particularly described here are similar to the first embodiment.

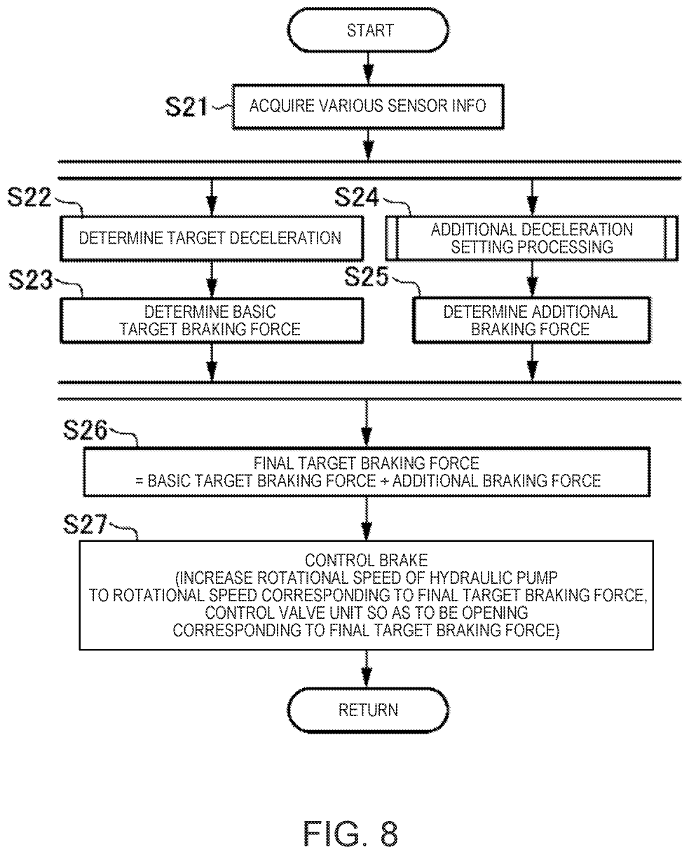

First, a vehicle posture control processing according to the second embodiment of the present disclosure is described with reference to FIG. 8. FIG. 8 is a flowchart of the vehicle posture control processing according to the second embodiment of the present disclosure.

First, at Step S21, the controller 14 acquires the detection signals outputted from the various sensors, as information on the operating state. Next, at Step S22, the controller 14 sets a target deceleration to be applied to the vehicle 1 based on the operating state of the vehicle 1 acquired at Step S21. In detail, a deceleration map (not illustrated) which defines a deceleration corresponding to a brake-pedal stepping amount, a brake-pedal stepping speed, and a vehicle speed is stored in advance in the memory. The controller 14 refers to the deceleration map and determines the deceleration corresponding to the brake-pedal stepping amount, the brake-pedal stepping speed, and the vehicle speed, which are acquired at Step S21, as a target deceleration.

Next, at Step S23, the controller 14 sets a basic target braking force by the brake device 16 for achieving the target deceleration set at Step S22.

In parallel to the processing at Steps S22 and S23, the controller 14 performs, at Step S24, the additional deceleration setting processing described above (see FIGS. 4 to 6), and based on the steering speed of the steering wheel 6, it sets the deceleration to be applied to the vehicle 1 in order to control the vehicle posture.

Next, at Step S25, the controller 14 determines an additional braking force based on the additional deceleration set by the additional deceleration setting processing at Step S24. In detail, the controller 14 determines the additional braking force required for achieving the additional deceleration by adding the braking force, based on the current vehicle speed, the current road surface gradient, etc. which are acquired at Step S21.

After the processing at Steps S23 and S25, the controller 14 determines, at Step S26, a final target braking force based on the basic target braking force determined at Step S23 and the additional braking force determined at Step S25. For example, the controller 14 sets a value obtained by adding the additional braking force to the basic target braking force as the final target braking force.

Next, at Step S27, the controller 14 controls the brake device 16 to generate the final target braking force determined at Step S26. In detail, the controller 14 outputs a braking-force command value to the brake control system 18 based on the final target braking force determined at Step S26. For example, the brake control system 18 stores in advance a map which defines a relationship between the braking-force command value and the rotational speed of the hydraulic pump 20, and refers to this map and actuates the hydraulic pump 20 at a rotational speed corresponding to the braking-force command value (in one example, the power supplied to the hydraulic pump 20 is increased to increase the rotational speed of the hydraulic pump 20 to the rotational speed corresponding to the braking-force command value). Moreover, for example, the brake control system 18 stores in advance a map which defines a relationship between the braking-force command value and the opening of the valve unit 22, and refers to this map and controls the valve units 22 individually so that the opening becomes the opening corresponding to the braking-force command value (in one example, the power supplied to the solenoid valve is increased to increase the opening of the solenoid valve to the opening corresponding to the braking-force command value) to adjust the braking force of each wheel. After Step S27, the controller 14 ends the vehicle posture control processing.

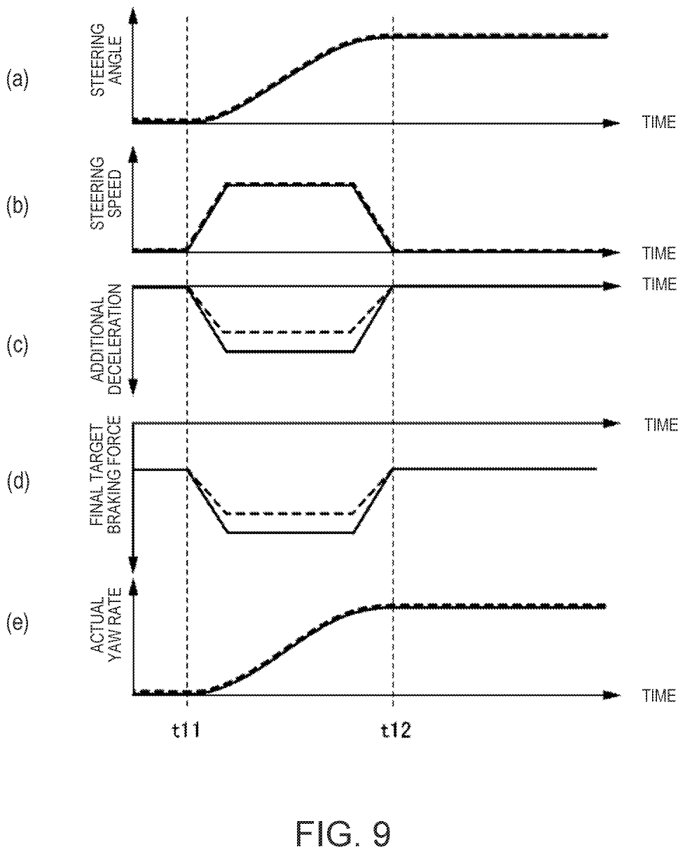

Next, operation of the control system for the vehicle according to the second embodiment of the present disclosure is described with reference to FIG. 9. FIG. 9 is a time chart illustrating temporal changes in the various parameters relevant to the vehicle posture control when the vehicle 1 on which the control system for the vehicle according to the second embodiment of the present disclosure is mounted is turned.

In FIG. 9, chart (a) indicates the steering angle, chart (b) indicates the steering speed, chart (c) indicates the additional deceleration, chart (d) indicates the final target braking force, and chart (e) indicates the actual yaw rate. In FIG. 9, a solid line indicates the changes in the parameters during off-road traveling, and a broken line indicates the changes in the parameters during on-road traveling. Here, similar turning operations of the steering wheel 6 are performed both during off-road traveling and during on-road traveling (charts (a) and (b)). Note that, in FIG. 9, charts (a) to (c) and (e) are the same as those of FIG. 7, and chart (d) differs from FIG. 7.

In detail, in the second embodiment, the final target braking force is set as illustrated in chart (d) according to the additional deceleration illustrated in chart (c) which is set based on the steering angle and the steering speed (see charts (a) and (b)). That is, since the steering angle is the same during off-road traveling and during on-road traveling, the additional deceleration and the final target braking force (absolute value) become larger during off-road traveling than during on-road traveling. Then, by controlling the brake device 16 to generate such a final target braking force, the actual yaw rate as illustrated in chart (e) is exhibited by the vehicle 1. In detail, the almost same actual yaw rate is exhibited by the vehicle 1 during off-road traveling and during on-road traveling.

Also according to the second embodiment, since the additional deceleration applied to the vehicle posture control is made larger during off-road traveling than during on-road traveling, the desired vehicle posture can be appropriately achieved also during off-road traveling. That is, by applying the additional deceleration set comparatively large during off-road traveling, the insufficient sinking of the vehicle body front part by the vehicle posture control can be solved appropriately, and it becomes possible to achieve the desired vehicle turning performance.

### Third Embodiment

Next, a third embodiment of the present disclosure is described. In the first embodiment, when a turning operation of the steering wheel 6 is carried out, the posture control of the vehicle 1 is executed by reducing the generated torque of the engine 4. However, in the third embodiment, when a turning operation of the steering wheel 6 is carried out, the set additional deceleration is added to the vehicle 1 by causing a generator which is driven by the wheels to perform regeneration. Note that in the following, as for the same configuration and processing as the first embodiment described above, description thereof is suitably omitted. That is, the configuration and processing which are not particularly described here are similar to the first embodiment.

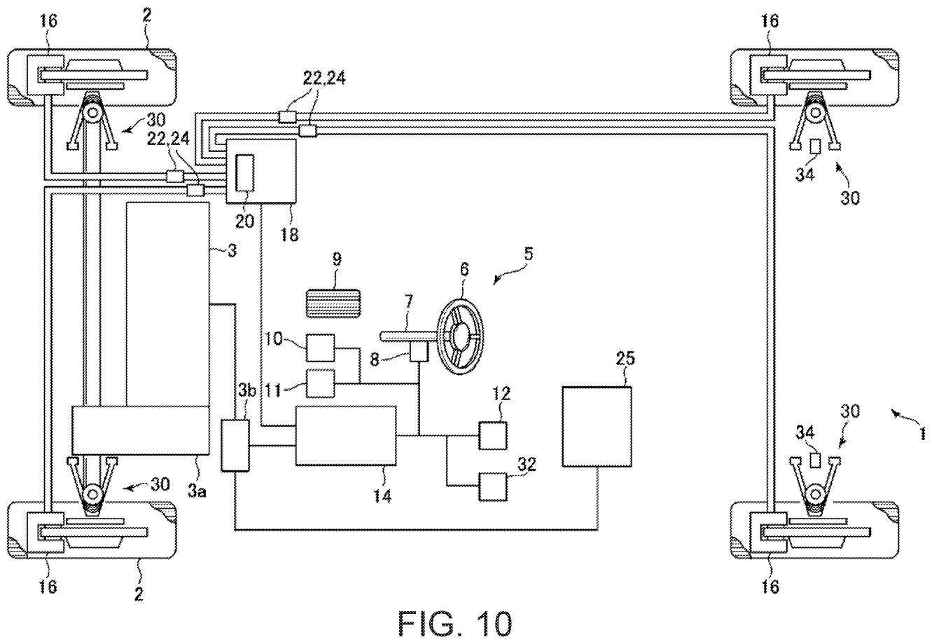

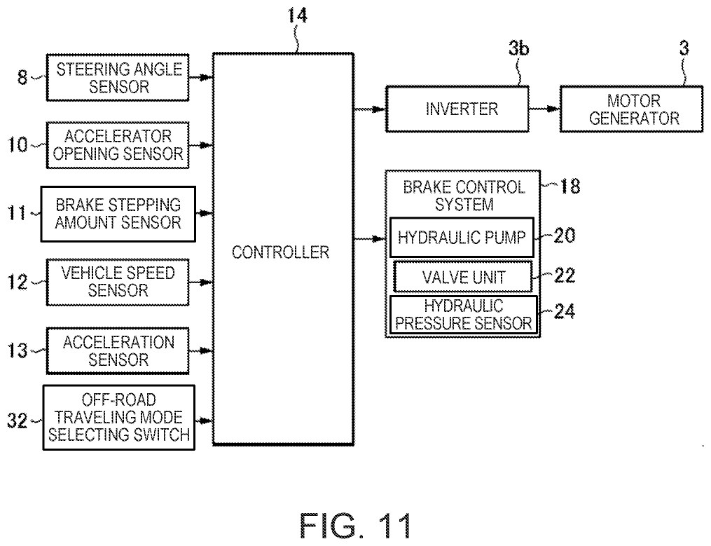

First, a configuration of the vehicle on which a control system for the vehicle according to the third embodiment of the present disclosure is mounted is described with reference to FIGS. 10 and 11. FIG. 10 is a block diagram illustrating the overall configuration of the vehicle on which the control system for the vehicle according to the third embodiment of the present disclosure is mounted, and FIG. 11 is a block diagram illustrating an electrical configuration of the control system for the vehicle according to the third embodiment of the present disclosure.

In the third embodiment, as illustrated in FIGS. 10 and 11, a motor generator 3 having a function to drive the front wheels 2 (i.e., a function as an electric motor), and a function to regenerate power by being driven by the front wheels 2 (i.e., a function as a generator) is mounted on the vehicle 1. A force is transmitted to the motor generator 3 from the front wheels 2 through a transmission 3a, and the motor generator 3 is controlled by the controller 14 through an inverter 3b. Further, the motor generator 3 is connected with a battery 25 through the inverter 3b, and when generating a driving force, the power is supplied from the battery 25, and when regenerating the power, the power is supplied to the battery 25 to charge the battery 25.

The controller 14 performs a control for the motor generator 3 and the brake control system 18 based on the detection signals outputted from the various sensors which detect the operating state of the vehicle 1. In detail, when driving the vehicle 1, the controller 14 calculates for the target torque (driving torque) to be given to the vehicle 1, and it outputs the control signal to the inverter 3b so that the motor generator 3 generates the target torque. On the other hand, when braking the vehicle 1, the controller 14 calculates a target regeneration torque to be given to the vehicle 1, and it outputs the control signal to the inverter 3b so that the motor generator 3 generates the target regeneration torque. Moreover, when braking the vehicle 1, the controller 14 may calculate a target braking force to be given to the vehicle 1 alternatively or additionally to using such a regeneration torque, and may output the control signal to the brake control system 18 so that the target braking force is achieved. In this case, by controlling the hydraulic pump 20 and the valve unit 22 of the brake control system 18, the controller 14 generates the desired braking force by the brake device 16.

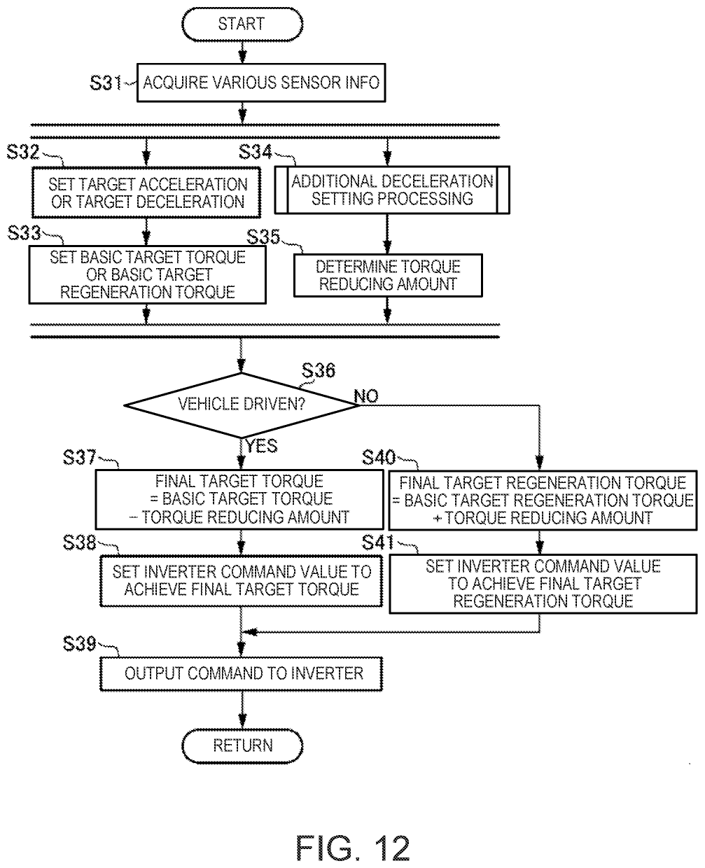

Next, a vehicle posture control processing executed by the control system for the vehicle in the third embodiment of the present disclosure is described with reference to FIG. 12. FIG. 12 is a flowchart of the vehicle posture control processing according to the third embodiment of the present disclosure.

As illustrated in FIG. 12, at Step S31, the controller 14 acquires the detection signals outputted from the various sensors, as the information on the operating state. Next, at Step S32, the controller 14 sets the target acceleration or the target deceleration to be applied to the vehicle 1 based on the operating state of the vehicle 1 acquired at Step S31. In detail, the controller 14 sets the target acceleration or the target deceleration based on the accelerator stepping amount, the brake-pedal stepping amount, the vehicle speed, etc.

Next, at Step S33, if the target acceleration is set at Step S32, the controller 14 sets a basic target torque of the motor generator 3 for achieving the target acceleration, and on the other hand, if the target deceleration is set at Step S32, it sets a basic target regeneration torque of the motor generator 3 for achieving the target deceleration.

Moreover, in parallel to the processing at Steps S32 and S33, the controller 14 performs, at Step S34, the additional deceleration setting processing described above (see FIGS. 4 to 6), and based on the steering speed of the steering wheel 6, it sets the deceleration to be applied to the vehicle 1 in order to control the vehicle posture.

Next, at Step S35, the controller 14 determines the torque reducing amount based on the additional deceleration set by the additional deceleration setting processing at Step S34. In detail, the controller 14 determines an amount of torque required for achieving the additional deceleration by lowering the generated torque of the motor generator 3 or increasing the regeneration torque, based on the current vehicle speed, gear stage, road surface gradient, etc. which are acquired at Step S31.

Next, at Step S36, the controller 14 determines whether the vehicle 1 is driven (i.e., whether the vehicle 1 is braked). In one example, if the basic target torque is set at Step S33 (i.e., if the target acceleration is set at Step S32), the controller 14 determines that the vehicle 1 is driven, and on the other hand, if the basic target regeneration torque is set at Step S33 (i.e., if the target deceleration is set at Step S32), it determines that the vehicle 1 not driven. In another example, the controller 14 may perform this determination based on the detection signals from the accelerator opening sensor 10 and the brake stepping amount sensor 11.

If the controller 14 determines at Step S36 that the vehicle 1 is driven (Step S36: YES), it determines, at Step S37, a final target torque based on the basic target torque set at Step S33 and the torque reducing amount set at Step S35. In detail, the controller 14 sets a value obtained by subtracting the torque reducing amount from the basic target torque as the final target torque. That is, the controller 14 reduces the driving torque given to the vehicle 1. Note that if the additional deceleration is not set at Step S34 (i.e., if the torque reducing amount is zero), the controller 14 applies the basic target torque as the final target torque as-is.

Next, at Step S38, the controller 14 sets a command value for the inverter 3b (inverter command value) for achieving the final target torque determined at Step S37. That is, the controller 14 sets the inverter command value (control signal) for causing the motor generator 3 to generate the final target torque. Then, at Step S39, the controller 14 outputs the inverter command value set at Step S38 to the inverter 3b. After Step S39, the controller 14 ends the vehicle posture control processing.

On the other hand, if the controller 14 determines that the vehicle 1 is not driven at Step S36, i.e., if the vehicle 1 is braked (Step S36: NO), it determines, at Step S40, a final target regeneration torque based on the basic target regeneration torque determined at Step S33 and the torque reducing amount determined at Step S35. In detail, the controller 14 sets a value obtained by adding the torque reducing amount to the basic target regeneration torque as the final target regeneration torque (in principle, the basic target regeneration torque and the torque reducing amount are expressed by positive values). That is, the controller 14 increases the regeneration torque (braking torque) given to the vehicle 1. Note that if the additional deceleration is not determined at Step S34 (i.e., if the torque reducing amount is zero), the controller 14 applies the basic target regeneration torque as the final target regeneration torque as-is.

Next, at Step S41, the controller 14 sets a command value for the inverter 3b (inverter command value) for achieving the final target regeneration torque determined at Step S40. That is, the controller 14 sets the inverter command value (control signal) for causing the motor generator 3 to generate the final target regeneration torque. Then, at Step S39, the controller 14 outputs the inverter command value set at Step S41 to the inverter 3b. After Step S39, the controller 14 ends the vehicle posture control processing.

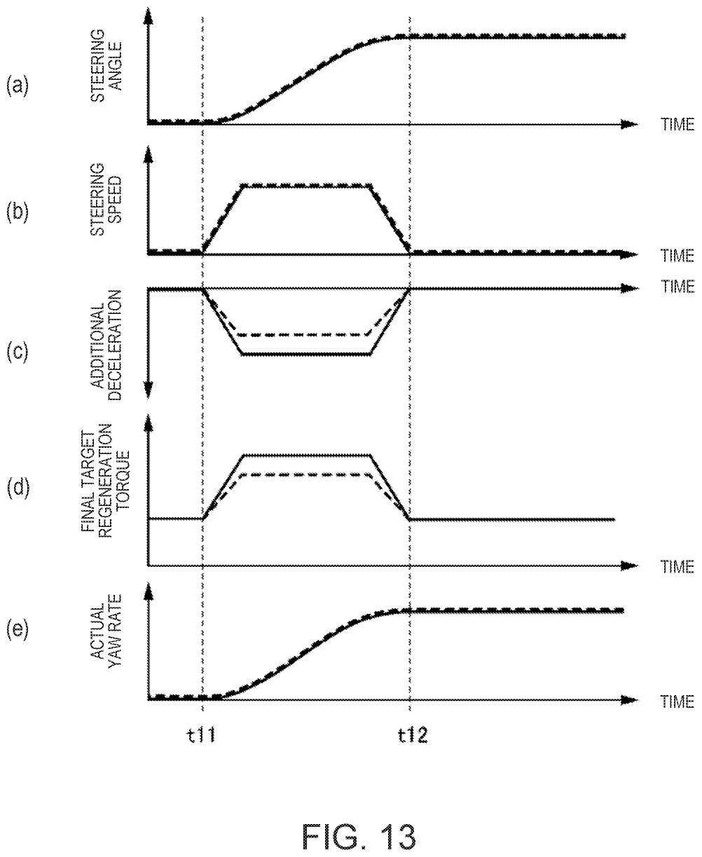

Next, operation of the control system for the vehicle according to the third embodiment of the present disclosure is described with reference to FIG. 13. FIG. 13 is a time chart illustrating temporal changes in the various parameters relevant to the vehicle posture control, when the vehicle 1 on which the control system for the vehicle according to the third embodiment of the present disclosure is mounted is turned, and illustrating a case where the vehicle 1 is not driven (i.e., “Step S36: NO” in the flowchart of FIG. 12).

In FIG. 13, chart (a) indicates the steering angle, chart (b) indicates the steering speed, chart (c) indicates the additional deceleration, chart (d) indicates the final target regeneration torque, and chart (e) indicates the actual yaw rate. In FIG. 13, a solid line indicates the changes in the parameters during off-road traveling, and a broken line indicates the changes in the parameters during on-road traveling. Here, similar turning operations of the steering wheel 6 are performed both during off-road traveling and during on-road traveling (charts (a) and (b)). Note that in FIG. 13, charts (a) to (c) and (e) are the same as those of FIG. 7, and chart (d) differs from FIG. 7.

In detail, in the third embodiment, the final target regeneration torque is set as illustrated in chart (d) according to the additional deceleration illustrated in chart (c) which is set based on the steering angle and the steering speed (see charts (a) and (b)). That is, since the steering angle is the same during off-road traveling and during on-road traveling, the additional deceleration and the final target regeneration torque (absolute value) become larger during off-road traveling than during on-road traveling. Then, by controlling the motor generator 3 to generate such a final target regeneration torque, the actual yaw rate as illustrated in chart (e) is exhibited by the vehicle 1. In detail, the almost same actual yaw rate is exhibited by the vehicle 1 during off-road traveling and during on-road traveling.

Also according to the third embodiment, since the additional deceleration applied to the vehicle posture control is made larger during off-road traveling than during on-road traveling, the desired vehicle posture can be appropriately achieved also during off-road traveling. That is, by applying the additional deceleration set comparatively large during off-road traveling, the insufficient sinking of the vehicle body front part by the vehicle posture control can be solved appropriately, and it becomes possible to achieve the desired vehicle turning performance.

Note that FIG. 13 illustrates the time chart of the vehicle posture control (the control at Steps S40 and S41 is executed after “Step S36: NO” in FIG. 12) executed when the vehicle 1 is not driven (i.e., when the motor generator 3 regenerates power). On the other hand, when the vehicle 1 is driven, that is, in the vehicle posture control (the control at Steps S37 and S38 is executed after “Step S36: YES” in FIG. 12) executed when the motor generator 3 generates the driving force), the time chart becomes same as FIG. 7. That is, in the third embodiment, not the engine 4 but the motor generator 3 functions as the drive source so that the final target torque illustrated in chart (d) of FIG. 7 is achieved by the driving force by the motor generator 3.

### MODIFICATIONS

In the above embodiments, the maps M1 and M2 (see FIG. 6) defined according to the steering angle are used in order to make the applying additional deceleration larger during off-road traveling than during on-road traveling. That is, by correcting the additional deceleration by using the gains obtained from the maps M1 and M2 defined according to the steering angle, the additional deceleration applied during off-road traveling is set larger than the additional deceleration applied during on-road traveling. In one modification, the additional deceleration applied during off-road traveling may be set larger than the additional deceleration applied during on-road traveling without using the maps M1 and M2 defined according to the steering angle. In one example, the additional deceleration set at Step S14 of FIG. 4 (i.e., the additional deceleration set according to the steering speed based on the map of FIG. 5) may be corrected, regardless of the steering angle, so that it is increased by a fixed rate during off-road traveling compared to during on-road traveling. In another example, a map which defines the gain for correcting the additional deceleration may be created using the lateral acceleration and the vehicle speed, instead of using the steering angle, and by using the map, the additional deceleration applied during off-road traveling may be set larger than the additional deceleration applied during on-road traveling.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### DESCRIPTION OF REFERENCE CHARACTERS

1 Vehicle
2 Front Wheel
3 Motor Generator
4 Engine
6 Steering Wheel
8 Steering Angle Sensor
9 Accelerator Pedal
10 Accelerator Opening Sensor
12 Vehicle Speed Sensor
13 Acceleration Sensor
14 Controller
16 Brake Device
18 Brake Control System
32 Off-road Traveling Mode Selecting Switch

What is claimed is:

1. A control system for a vehicle, comprising:
a steering wheel configured to be operated by a driver;
a steering angle sensor configured to detect a steering angle corresponding to operation of the steering wheel; and
a controller configured to set an additional deceleration to be applied to the vehicle based on the steering angle detected by the steering angle sensor to control a vehicle posture when the steering wheel is turned, and applies the additional deceleration to the vehicle,
wherein the controller sets the additional deceleration larger when the vehicle travels off road than when the vehicle does not travel off road.

2. The control system of claim 1, further comprising a switch for selecting at least an off-road traveling mode as a traveling mode of the vehicle,
wherein, when the off-road traveling mode is selected by the switch, the controller sets the additional deceleration larger than the additional deceleration when the off-road traveling mode is not selected.

3. The control system of claim 2, wherein the controller increases the additional deceleration as the steering angle detected by the steering angle sensor increases, and sets the additional deceleration larger when the vehicle travels off road than when the vehicle does not travel off road, when compared at the same steering angle.

4. The control system of claim 3, further comprising a drive source configured to generate torque for driving the vehicle,
wherein the controller controls the drive source so that the generated torque of the drive source is reduced to apply the additional deceleration to the vehicle.

5. The control system of claim 3, further comprising a braking system configured to give a braking force to the vehicle,
wherein the controller controls the braking system so that the braking force of the braking system is given to the vehicle to apply the additional deceleration to the vehicle.

6. The control system of claim 3, further comprising a generator configured to be driven by wheels of the vehicle and regenerate power,
wherein the controller controls the generator so that the generator regenerates the power to apply the additional deceleration to the vehicle.

7. The control system of claim 4, wherein the controller calculates a steering speed based on the steering angle detected by the steering angle sensor, and sets the additional deceleration larger as the steering speed increases.

8. The control system of claim 1, wherein the controller increases the additional deceleration as the steering angle detected by the steering angle sensor increases, and sets the additional deceleration larger when the vehicle travels off road than when the vehicle does not travel off road, when compared at the same steering angle.

9. The control system of claim 1, further comprising a drive source configured to generate torque for driving the vehicle,
wherein the controller controls the drive source so that the generated torque of the drive source is reduced to apply the additional deceleration to the vehicle.

10. The control system of claim 1, further comprising a braking system configured to give a braking force to the vehicle,
wherein the controller controls the braking system so that the braking force of the braking system is given to the vehicle to give the additional deceleration to the vehicle.

11. The control system of claim 1, further comprising a generator configured to be driven by wheels of the vehicle and regenerate power,
wherein the controller controls the generator so that the generator regenerates the power to apply the additional deceleration to the vehicle.

12. The control system of claim 1, wherein the controller calculates a steering speed based on the steering angle detected by the steering angle sensor, and sets the additional deceleration larger as the steering speed increases.

13. The control system of claim 3, wherein the controller calculates a steering speed based on the steering angle detected by the steering angle sensor, and sets the additional deceleration larger as the steering speed increases.

14. The control system of claim 5, wherein the controller calculates a steering speed based on the steering angle detected by the steering angle sensor, and sets the additional deceleration larger as the steering speed increases.

15. The control system of claim 6, wherein the controller calculates a steering speed based on the steering angle detected by the steering angle sensor, and sets the additional deceleration larger as the steering speed increases.

16. The control system of claim 2,
wherein the controller includes a first map and a second map defining gains to be used for correcting the additional deceleration calculated according to the steering speed,
wherein both the first map and the second map are defined so that the gain becomes larger as the steering angle increases,
wherein the gain is defined to be larger in a range of the second map where the steering angle is below a given value than in a range of the first map where the steering angle is below the given value,
wherein, when the switch is off, the controller controls the vehicle so that the additional deceleration is corrected based on the gain calculated from the first map, and when the switch is on, the controller controls the vehicle so that the additional deceleration is corrected based on the gain calculated from the second map.

17. The control system of claim 16, wherein the gain in a range of the second map where the steering angle is above the given value is the same as the gain in a range of the first map where the steering angle is above the given value.

18. The control system of claim 17, wherein the gains of the first map and the second map in the range where the steering angle is above the given value is 1 so that the additional deceleration calculated according to the steering speed is used as-is.
